(19) United States
(12) Patent Application Publication
(10) Pub. No.: US 2019/0006852 A1
(43) Pub. Date: Jan. 3, 2019

(54) ELECTRICAL POWER DISTRIBUTION BOX FOR ONBOARD NETWORK OF AN AIRCRAFT AND CORRESPONDING ELECTRICAL POWER SUPPLY SYSTEM

(71) Applicant: ZODIAC AERO ELECTRIC, Montreuil (FR)

(72) Inventors: Loïc Aoustin, Montreuil (FR); Stéphane Guenot, Montreuil (FR)

(73) Assignee: ZODIAC AERO ELECTRIC, Montreuil (FR)

(21) Appl. No.: 15/996,200

(22) Filed: Jun. 1, 2018

(30) Foreign Application Priority Data
Jun. 29, 2017 (FR) 1756036

(51) Int. Cl. H02J 4/00; B64D 41/00

(52) U.S. Cl. CPC H02J 4/00; H02M 3/155; B64D 41/00

(57) ABSTRACT

This electrical power distribution box for an aircraft electrical power supply network, which is intended to be connected to loads for powering said loads at a first voltage level and at a second voltage level lower than the first voltage level comprises a set of distribution modules for powering loads at said first voltage level. It further comprises a solid state converter capable of converting the first voltage level into a voltage at the second voltage level for powering loads at said second voltage level.

### BACKGROUND

The invention relates, generally, to the distribution of electrical power in an aircraft and relates in particular to an electrical power distribution box of an electrical network of an aircraft.

The electrical power distribution in an aircraft is generally hierarchically organized. First of all, the electrical power is produced mainly from generators driven by the engines of the aircraft. This power is then conveyed by means of cables to primary distribution boxes. These primary distribution boxes then send this electrical power to secondary distribution boxes. The embedded loads connected to the onboard network are powered from the secondary distribution boxes, even directly from the primary distribution boxes.

The architectures of the electrical distribution systems for aircraft tend to evolve because of the increase in electrical power conveyed.

The voltage of the onboard network, originally at 28 Vdc, is gradually changed to three phase 115 Vac at fixed frequency, then at variable frequency, with the aim of eliminating the hydraulic networks, for reasons of ease of maintenance and of reduction of the embedded weight, notably due to the wiring, to the generators and other equipment items.

The voltage levels in the current aeroplanes follow the same trend. They can be 230 Vac and plus or minus 135 Vdc. However, the networks at 28 Vdc and 115 Vac are still present in business aeroplanes and on commercial jumbo jets.

FIG. 1 shows an example of electrical power distribution architecture of a commercial jumbo jet.

In this type of architecture, the electrical power is supplied by a generator G which is driven by the engine M of an aeroplane and which delivers an alternating voltage to a bus B, here a 230 volt alternating voltage.

In the exemplary embodiment illustrated, the distribution architecture is intended to power loads at an alternating voltage of 115 Vac and loads at a direct voltage of 28 Vdc.

The distribution system thus comprises an autotransformer ATU which converts the alternating voltage conveyed by the bus B into a 115 Vac alternating voltage and a voltage converter rectifier TRU which converts the voltage available on the bus B into a direct voltage of 28 Vdc.

The voltages supplied by the autotransformer ATU and by the converter TRU are supplied to a secondary distribution box SPDB, for “Secondary Power Distribution Box”, which powers the loads at respective voltages of 115 Vac and 28 Vdc.

As can be seen, circuit breakers, such as D, or contactors, are distributed in the distribution network to ensure protection for the various elements of the architecture.

According to this architecture, the two voltage levels 115 Vac and 28 Vdc have to be brought from the bus B of the electrical core to the distribution box SPDB. Now, for a jumbo jet, the electrical power consumed by the loads powered at 28 Vdc, such as the cabin and cockpit equipment items, is relatively high. Furthermore, the lengths of cables needed to distribute the voltages between the converter rectifier TRU and the distribution box are relatively great. They can be of the order of 15 km, for 8 gauge cables, with a weight per unit of line length of approximately 39 kg per kilometre. On the contrary, the cables needed to convey the 115 Vac voltages have a lesser section and, consequently, a lesser weight per unit of line length. The total weight of the wiring used in a jumbo jet aircraft power supply network to convey a voltage of 115 Vac is consequently less, for example of the order of 1.5 kg.

Moreover, the galvanic insulation between the 28 Vdc and 115 Vac networks is produced by the converter rectifier TRU.

Because of the frequency dynamics of the 115 Vac network, the converter TRU has to have a magnetic core of increased volume and therefore of a relatively significant weight. Moreover, the 28 Vdc voltage which powers the loads is not regulated, which leads to an overdimensioning of the equipment items which have been supplied with power and have to withstand voltages that can range up to 42 Vdc, even 80 Vdc, or requires the addition of a stage of conversion of 28 Vdc into a regulated voltage which will then be used for the electronic functions of these equipment items.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The aim of the invention is therefore to overcome all or part of the prior-art deficiencies described above.

Its subject is therefore an electrical power distribution box for aircraft electrical power supply network, which is intended to be connected to loads to power said loads at a first voltage level and at a second voltage level lower than the first voltage level, said box comprising a set of distribution modules for powering loads at said first voltage level.

Another subject of the invention according to a second aspect, is a power supply system for aircraft, comprising a generator, a power supply bus powered by the generator and at least one electrical power distribution box connected to the power supply bus via an autotransformer, comprising a distribution box as defined above.

### DESCRIPTION OF THE DRAWINGS

Other aims, features and advantages of the invention will become apparent on reading the following description, given purely as a nonlimiting example, and with reference to the attached drawings in which:

FIG. 1, already mentioned, illustrates an electrical power distribution architecture according to the state of the art;

FIG. 2 illustrates an exemplary embodiment of an electrical power supply system for aircraft according to an embodiment of the invention;

FIG. 3 is a schematic diagram of a first exemplary embodiment of a converter of a distribution box according to the invention;

FIG. 4 illustrates a variant embodiment of a converter of a distribution box according to the invention; and

FIGS. 5 to 9 illustrate various variant embodiments of a distribution box according to the invention.

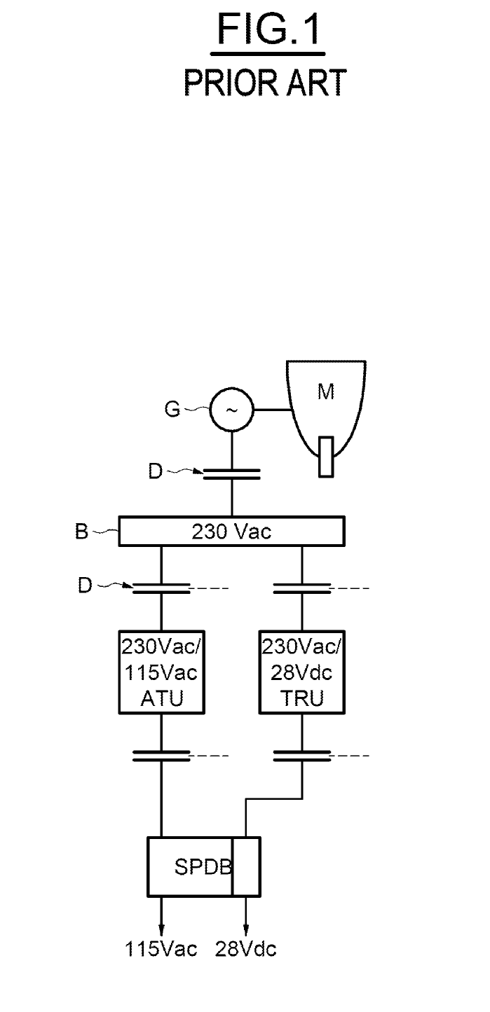

### DETAILED DESCRIPTION

Disclosed herein is an electrical power distribution box for aircraft electrical power supply network, which is intended to be connected to loads to power said loads at a first voltage level and at a second voltage level lower than the first voltage level, said box comprising a set of distribution modules for powering loads at said first voltage level.

According to a general feature, this box further comprises a solid state converter capable of converting the first voltage level into a voltage at the second voltage level for powering loads at said second voltage level.

Consequently, in the distribution networks conveying voltages of 28 Vdc and 115 Vac, the 28 Vdc is generated by a solid state converter situated as close as possible to the loads, the cables used according to the state of the art between the converter rectifier and the distribution box to convey the 28 Vdc being eliminated.

Moreover, the power that the TRU has to supply is greatly reduced.

Consequently, incorporating a solid state converter in the distribution box allows for a relatively significant weight saving which very greatly compensates the addition of the converter.

Thus, the invention allows for a reduction of the weight of wiring of the distribution network and of the conversion equipment items.

It is moreover possible to generate a voltage of 28 Vdc or, generally, a second voltage level, stabilized, from the voltage received at the input of the distribution box.

In one embodiment, the solid state converter comprises a switched mode power supply produced from switching components based on field effect transistors.

The solid state converter can also comprise a voltage converter rectifier (TRU), a DC/DC converter, an AC/AC converter or a DC/AC converter.

In one embodiment, the converter comprises at least one channel with semiconductor power converter (SSPC) capable of powering loads at said second voltage level.

Advantageously, at least some of the distribution modules comprise a channel with semiconductor power converters (SSPC).

The distribution box can moreover further comprise a set of distribution boards connected to the converters and comprising at least one channel with semiconductor power converters for powering loads at said second voltage level.

In one embodiment, the distribution box comprises an electrical power storage module connected between the converter and the distribution boards.

Another subject of the invention according to a second aspect, is a power supply system for aircraft, comprising a generator, a power supply bus powered by the generator and at least one electrical power distribution box connected to the power supply bus via an autotransformer, comprising a distribution box as defined above.

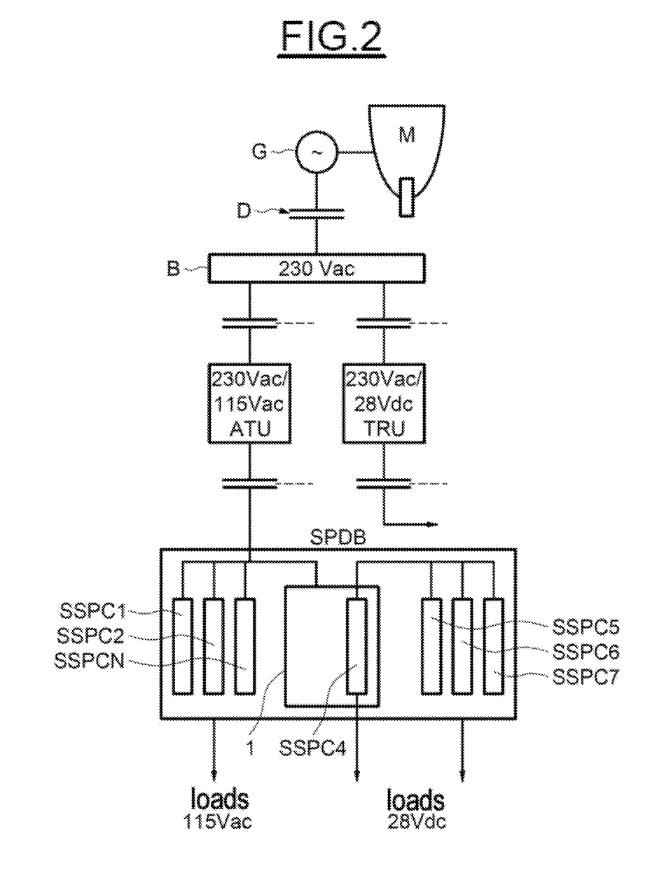

Reference is made first of all to FIG. 2 which illustrates an electrical power distribution system for aircraft according to the invention.

Such a system is for example intended to be embedded onboard a commercial aeroplane of jumbo jet type or in a business aeroplane of jet type in which the distribution networks jointly convey direct and alternating voltage levels of 28 Vdc and 115 Vac respectively.

However, obviously, there is no departure from the scope of the invention when the distribution system is intended to supply two different voltage levels to an onboard network of an aircraft, respectively high and low, involving a relatively high consumed electrical power.

FIG. 2 shows the engine M which drives a generator G here supplying a bus B at an alternating voltage of 230 Vac and circuit breakers D connected between the distribution box and the bus and on the side of the generator.

The distribution system further comprises an autotransformer ATU transforming the voltage level available on the bus B into a first voltage level, here equal to 115 Vac, and a converter rectifier TRU intended to convert and rectify the voltage conveyed on the bus B into a second voltage level, here equal to 28 Vdc, lower than the first voltage level.

This converter rectifier TRU is intended to directly power loads located for example in immediate proximity to the converter.

The autotransformer ATU is connected to a distribution box SPDB which receives at the input, the voltage converted by the autotransformer.

The distribution box comprises one or more, in particular three, distribution channels SSPC1, SSPC2, SPPCN each comprising a semiconductor power converter or SSPC, for “Solid State Power Controller”, to distribute the 115 Vac alternating voltage to the loads.

The distribution box SPDB further comprises a solid state converter intended to convert the alternating voltage delivered by the autotransformer ATU to the 28 Vdc direct voltage to power the loads at this voltage.

The solid state converter 1 also incorporates one or more SSPC boards 4 for powering loads at 28 Vdc, by controlling the power while ensuring a protection of these loads.

The distribution box SPDB also comprises distribution boards connected to the solid state converter 1 so as to receive the converted voltage level, these distribution boards, here numbering three, each comprising an SSPC board, respectively SSPC5, SSPC6 and SSPC7.

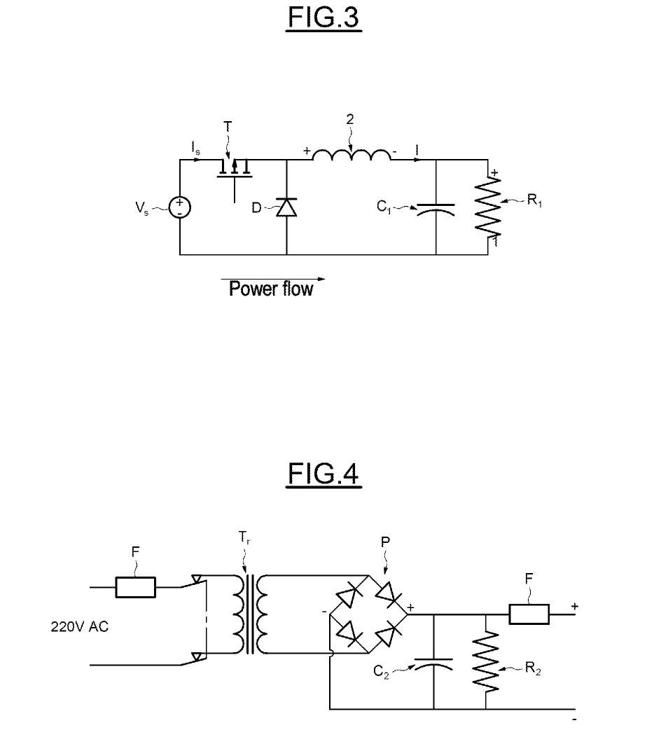

In one embodiment, the solid state converter constitutes a switched mode power supply, as can be seen in FIG. 3. As can be seen in this figure, this switched mode power supply is based on the use of a field effect transistor T, advantageously a MOSFET to ensure a rapid switching, delivering a converted voltage at the terminals of a resistor R1 from an input voltage VS by means of a magnetic circuit 2 associated with a diode D, and a capacitor C1.

As a variant, as illustrated in FIG. 4, the converter uses a transformer Tr capable of converting the alternating voltage at the first voltage level, here 220 volts, into an alternating voltage at the second voltage level, here 28 volts, and a rectifier stage composed of a diode bridge P capable of delivering a direct voltage at the second voltage level via a filtering stage comprising a capacitor C2 and a resistor R2 arranged in parallel. Advantageously, fuses F are provided at the input and at the output of the autotransformer.

Thus, the solid state converter, which can be incorporated without preference in a primary or secondary distribution equipment item, allows the generation of a 28 Vdc regulated voltage from a 115 Vac alternating voltage. This converter incorporates a so called “degraded” operating mode allowing the powering of essential or critical loads in the event of failure of components of one or more phases of the input network. As indicated previously, it also incorporates an SSPC control function making it possible to distribute, on independent and protected outputs, the voltage to different loads. Thus, the relatively low voltage cables between the transformer and the distribution box are eliminated such that the power that the transformer has to supply is greatly reduced.

The weight savings due to the wiring and the reduction of the weight of the transformer very greatly compensate the addition of the solid state converter in the distribution box. Since the 28 Vdc distributed to the loads is generated by a solid state converter, the voltage of the network is regulated over a greatly extended operating range, both in the variations of the input voltage and for the range of current of the 28 Vdc loads. Finally, the incorporation of a part of the secondary distribution in the converter makes it possible to pool the low voltage power supply which, in the state of the art, was specific to each SSPC board and to the optimization of the secondary distribution. Since the bus voltage is regulated, the power components are subjected to a lower voltage stress and are therefore more efficient.

Thus, the invention presents the following advantages:
reduction of the weight of the wiring in the onboard network of the aeroplane and of the sources and conversion equipment items upstream of the distribution box,
generation of a stabilized 28 Vdc voltage and absence of overvoltage,
incorporation of a part of the secondary distribution done by SSPCs,
incorporation of the low level power supplies of the SSPC channels without requiring auxiliary power supply,
optimization of the secondary distribution function because of the supply of a regulated voltage,
possible use of the distribution box with separation of the essential and non essential loads in case of abnormal operation such as loss of phase, breakage of a component, etc.,
possible incorporation of a converter in an existing equipment item, of SPDB or other type, in as much as the distribution box will be able to adopt the same mechanical and electrical interfaces as an element that it might replace.

The invention further makes it possible to use an existing SPDB distribution box by equipping it with a solid state converter.

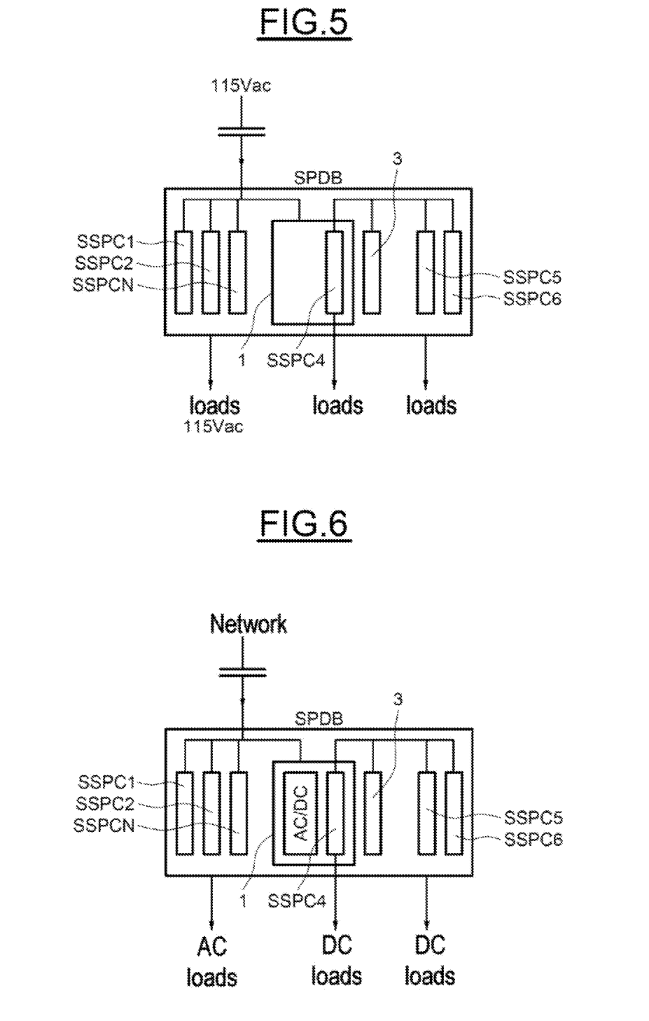

As illustrated in FIG. 5 which illustrates the distribution box and on which can be seen the channels SSPC1, SSPC2 and SSPCN distributing 115 Vac alternating voltage to loads, the solid state converter 1 with its load powering board SSPC4 and the boards SSPC5 and SSPC6 connected to the solid state converter, the distribution box further comprises an additional board 3 powered from the solid state converter 1 at 28 Vdc. This board is, for example, a power storage board serving as buffer to, for example, store the power when the available voltage is greater than the distributed voltage and to maintain the output voltage in case of momentary loss of the power supply supplied by the bus B.

FIGS. 6 to 9 finally illustrate various implementations of a distribution box provided with a solid state converter according to the invention.

Indeed, as indicated previously, the distribution box described previously is not limited to powering loads at 115 Vac, on the one hand, and at 28 Vdc on the other hand.

Referring to FIG. 6, the distribution box according to the invention can be connected to an alternating network delivering a first voltage level and ensuring the powering of AC load by means the boards SSPC1, SSPC2 and SSPCN at the first voltage level.

The solid state converter 1 incorporates an AC/DC converter to deliver a second direct voltage level for powering respective loads.

In the exemplary embodiment illustrated in FIG. 6, which corresponds to the embodiment of FIG. 5, the distribution box 1 incorporates a board SSPC4 for powering DC loads and is connected to boards SSPC5 and SSPC6 for powering respective loads. In this embodiment, it is also provided with a board 3 ensuring, for example, the power storage.

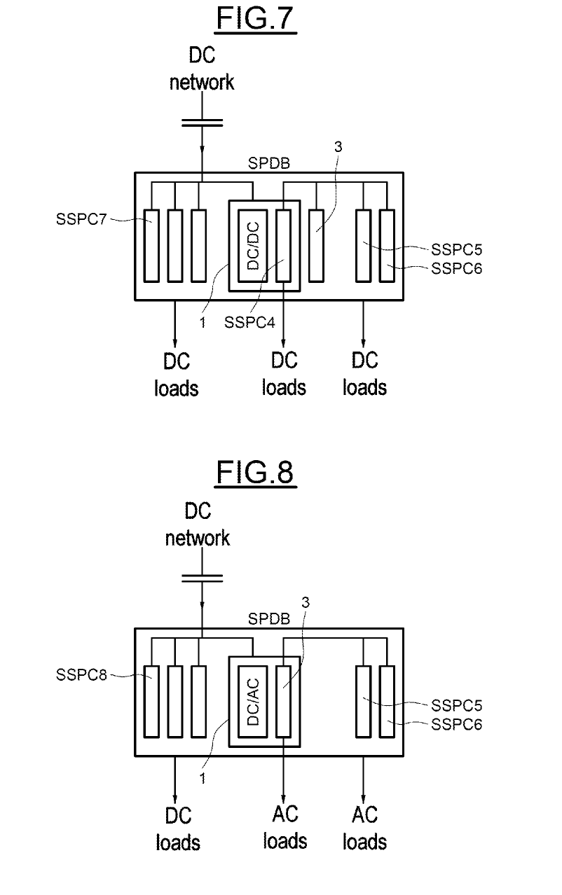

In the embodiment of FIG. 7, the distribution board SPDB is connected to a DC direct network. It comprises a set of boards SSPC7 with semiconductor power converter for powering DC loads from the direct power supply supplied by the network. The converter comprises, in this case, a DC/DC converter for powering DC loads.

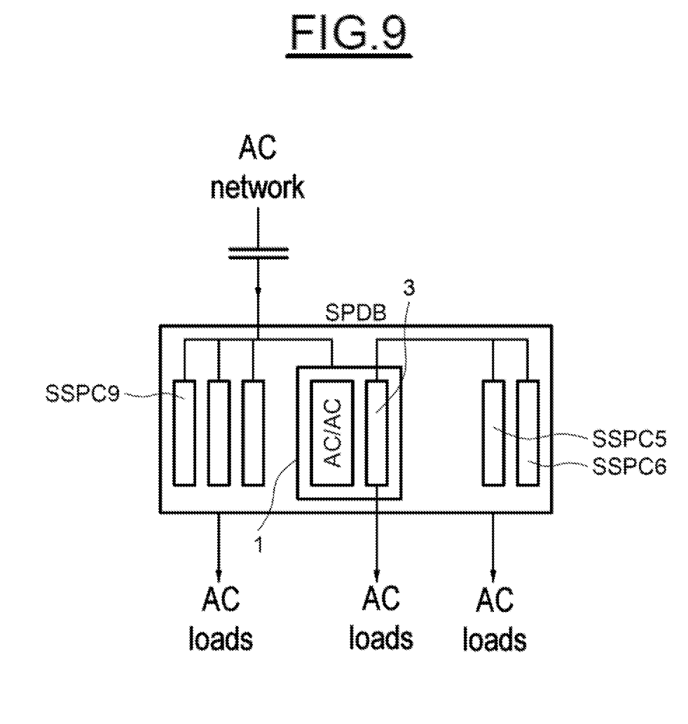

In the embodiment of FIGS. 8 and 9, the power supply box SPDB is connected respectively to a direct network DC and to an alternating network AC.

In the embodiment of FIG. 8, the box comprises a set of boards SSPC8 with semiconductor power converter for powering DC loads and the solid state converter comprises a DC/AC converter for powering AC loads.

In the embodiment of FIG. 9, the box SPDB comprises a set of boards with power converter SSPC9 ensuring the powering of AC loads, whereas the solid state converter 1 comprises an AC/AC converter for powering AC loads.

Thus, the power supply box incorporates, in various embodiments, a solid state power converter which ensures a conversion and a distribution from various alternating or direct voltage levels at a direct or alternating voltage for powering voltage networks at different direct or alternating voltage values.

While illustrative embodiments have been illustrated and described, it will be appreciated that various changes can be made therein without departing from the spirit and scope of the invention.

The embodiments of the invention in which an exclusive property or privilege is claimed are defined as follows:

1. An electrical power distribution box for an aircraft electrical power supply network, said box being configured to be connected to loads to power said loads at a first voltage level and at a second voltage level lower than the first voltage level and comprising a set of distribution modules for powering loads at said first voltage level, characterized in that it further comprises a solid state converter capable of converting the first voltage level received as input of the box into a voltage at the second voltage level for powering loads at said second voltage level.

2. The electrical power distribution box according to claim 1, in which the solid state converter comprises a switched mode power supply produced from switching components based on field effect transistors.

3. The electrical power distribution box according to claim 1, in which the solid state converter comprises a voltage converter rectifier.

4. The electrical power distribution box according to claim 1, in which the solid state converter comprises a DC/DC converter.

5. The electrical power distribution box according to claim 1, in which the solid state converter comprises an AC/AC converter.

6. The electrical power distribution box according to claim 1, in which the solid state converter comprises a DC/AC converter.

7. The electrical power distribution box according to claim 1, in which the converter comprises at least one channel with semiconductor power converter capable of powering loads at said second voltage level.

8. The electrical power distribution box according to claim 1, in which at least some of the distribution modules comprise a channel with semiconductor power converter.

9. The electrical power distribution box according to claim 1, further comprising a set of distribution boards connected to the solid state converter and comprising at least one channel with semiconductor power converter for powering loads at said second voltage level.

10. The electrical power distribution box according to claim 9, comprising a power storage module connected between the solid state converter and the distribution boards.

11. An electrical power supply system for aircraft, comprising a generator, a power supply bus powered by the generator and at least one electrical distribution box connected to the power supply bus via an autotransformer, characterized in that it comprises an electrical power distribution box according to claim 1.
